(19) United States
(12) Patent Application Publication
(10) Pub. No.: US 2007/0125787 A1
(43) Pub. Date: Jun. 7, 2007

(54) Thermally-insulating cup holding sleeve

(76) Inventors: Joseph A. Oathout, Anchorage, AK (US); Sandra L. Oathout, Anchorage, AK (US)

Correspondence Address: Galasso & Associates, LP, P.O. Box 26503, Austin, TX, 78755-0503, US

(21) Appl. No.: 11/599,051

(22) Filed: Nov. 14, 2006

Related U.S. Application Data
(60) Provisional application No. 60/742,500, filed on Dec. 5, 2005.

(51) Int. Cl. A47J 41/00

(52) U.S. Cl. 220/592.16; 220/903

(57) ABSTRACT

A thermally-insulating cup holding sleeve comprises an elongated cover, a strip of foam material and a plurality of cup gripping members. The elongated cover has opposing end portions thereof attached to each other such that the elongated cover forms a tapered sleeve body having an interior face and an exterior face. The elongated cover includes an interior space extending along substantially an entire length of the elongated cover. The strip of foam material is disposed within the interior space of the elongated cover. The strip of foam material extends along substantially an entire length of the elongated cover. The plurality of cup gripping members is attached in a spaced-apart manner to the interior face of the elongated cover.

### CROSS REFERENCE TO RELATED APPLICATIONS

This patent application claims priority to co-pending U.S. Provisional Patent Application having Ser. No. 60/742,500 filed Dec. 5, 2005 entitled “Coffee Coat”, having a common applicant herewith and being incorporated herein in its entirety by reference.

### FIELD OF THE DISCLOSURE

The disclosures made herein relate generally to cup holding implements and, more particularly, to cup holding sleeves providing insulating properties.

### BACKGROUND

Disposable paperboard cups are routinely used in fast food and roadside restaurants to contain hot drinks “to go”. Such cups are typically of standardized sizes, normally frusto-conical (i.e., a truncated cone) with an upwardly open top rim adapted to receive one of several standard sizes of plastic lid. Because such cups have relatively thin walls, they can be literally too hot to handle, particularly when they contain coffee or tea at a temperature close to the boiling point of water.

Disposable paper or plastic beverage cups of the type having a smooth cylindrical or tapered sidewall with no handle are commonly used by coffee shops, fast food restaurants, convenience stores and the like. These cups have many advantages insofar as they are easy to dispense (generally from a cylindrical dispenser), may include graphics or written indicia on the outer sidewall for promotional purposes and are relatively inexpensive to make.

There are some disadvantages associated with these style cups, however, primarily relating to problems that a user may encounter in grasping, carrying and using the cups. Insofar as the disposable cup has a smooth outer surface, a user generally has to grasp the cup by placing his or her entire palm and fingers around the outside surface of the cup. If the user's hands are wet or dirty or if the user loosens his or her grip, the cup may partially slip or entirely drop out of the user's hand spilling the beverage on the user, the floor, etc.

Another related problem is that the paper or plastic material used to make these cups often times does not provide a sufficient amount of insulation to prevent the outside of the cup from getting hot when filled with hot chocolate, coffee, or the like. Since these cups do not have handles, the user is required to contact his or her entire palm around the cup, and heat generated from the hot beverage can result in discomfort to the user when handling the cup. This discomfort may become so great as to cause the user to drop the cup or to delay drinking the beverage until it has cooled to an undesirable temperature.

Many establishments offering hot drinks will “double-cup” the beverage, using two nested cups instead of a single cup. Double-cupping is of course very wasteful and increases the burden on the environment. Aside from the wastefulness, the practice of double-cupping does significantly reduce the rate at which heat passes outwardly through the double-wall of the cup.

Therefore, a sleeve engagable around a cup and that serves to protect a person's hand from hot walls of a plastic or paper cup is advantageous, desirable and useful.

### SUMMARY OF THE DISCLOSURE

Embodiments of the present invention provide for a sleeve engagable around a cup in a manner that protects a person's hand from hot walls of a plastic or paper cup. In one embodiment of the present invention, a thermally-insulating cup holding sleeve comprises a frusto-conical shaped insulating core, an outer cover and an inner cover. The frusto-conical shaped insulating core has an exterior face and an interior face. The outer cover is attached to the exterior face of the insulating core. The outer cover is made of a cloth material. The inner cover is attached to the inner face of the insulating core. The inner cover and the outer cover are each made of a respective cloth material.

In another embodiment of the present invention, a thermally-insulating cup holding sleeve comprises a strip of foam material, a first cloth cover, a second cloth cover and a plurality of cup gripping members. The strip of foam material has opposing major faces, opposing end portions, an upper edge portion and a lower edge portion. The opposing end portions are joined to each other. Each one of the edge portions of the strip of foam material are correspondingly arched such that the strip of foam material forms a frusto-conical shaped sleeve when the opposing end portions of the strip of foam material are joined. The first cloth cover overlays and is attached to essentially an entire portion of a first one of the opposing major faces of the strip of foam material. Upper and lower edge portions of the first cloth cover are each wrapped around a corresponding one of the edge portions of the strip of foam material such that the edge portions of the first cloth cover each overlay a portion of a second one of the opposing major faces of the strip of foam material. The edge portions of the first cloth cover are attached to the second one of the opposing major faces of the strip of foam material. The second cloth cover overlays and is attached to essentially an entire exposed portion of the second one of the opposing major faces of the strip of foam material. Upper and lower edge portions of the second cloth cover are each attached to a corresponding one of the edge portions of the first cloth cover. The plurality of cup gripping members is attached to the second cloth cover. The cup gripping members are arranged in a spaced apart manner between the opposing end portions of the strip of foam material.

In another embodiment of the present invention, a thermally-insulating cup holding sleeve comprises an elongated cover, a strip of foam material and a plurality of cup gripping members. The elongated cover has opposing end portions thereof attached to each other such that the elongated cover forms a tapered sleeve body having an interior face (i.e., cup engaging face) and an exterior face (i.e., a hand engaging face). The elongated cover includes an interior space extending along substantially an entire length of the elongated cover. The strip of foam material is disposed within the interior space of the elongated cover. The strip of foam material extends along substantially an entire length of the elongated cover. The plurality of cup gripping members is attached in a spaced-apart manner to the interior face of the elongated cover.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a perspective view showing an embodiment of a thermally-insulating cup holding sleeve in accordance with the present invention.

FIG. 2 is a top view of the thermally-insulating cup holding sleeve shown in FIG. 1.

FIG. 3 is a cross-sectional view taken along the line 3-3 in FIG. 2.

### DETAILED DESCRIPTION OF THE DRAWING FIGURES

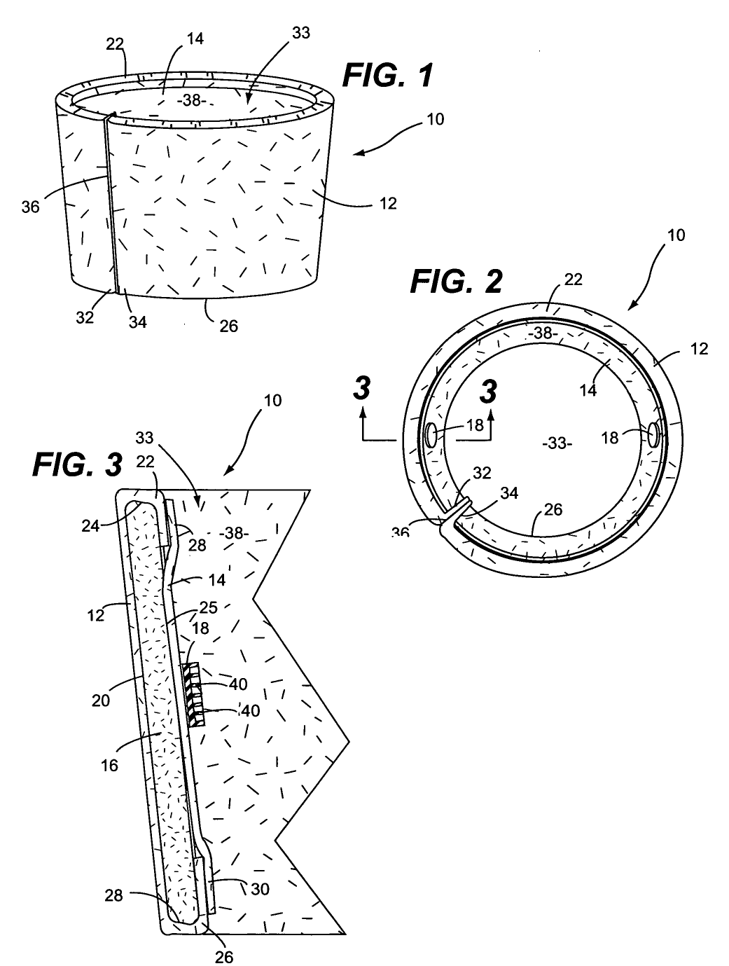

FIGS. 1-2 show various aspects of an embodiment of a thermally-insulating cup holding sleeve in accordance with the present invention, which is referred to herein as the thermally-insulating cup holding sleeve 10. The thermally-insulating cup holding sleeve 10 includes an outer cover 12, an inner cover 14, a strip of foam material 16 (FIG. 3) and a plurality of cup gripping members 18 (FIGS. 2 and 3). A woven cloth material such as cotton cloth, Spandex cloth and the like are examples of materials from which the outer cover 12 and the inner cover 14 may be made. A cellular foam insulating material such as Armaflex brand insulating foam offered by Armacell Enterprises is an example of a material from which the strip of foam material 16 may be made. It is disclosed herein that embodiments of the present invention are not unnecessarily limited to a particular type of configuration of cover material or insulating material. In generally, a cover material useful for the present invention will offer a suitable degree of conformability, flexibility and durability and an insulating material useful for the present invention will offer a suitable degree of flexibility, durability and thermal insulation.

The outer cover 12 overlays and is attached to essentially an entire portion of an outside face 20 (FIG. 3) of the strip of foam material 16. An upper edge portion 22 is wrapped around an upper edge portion 24 (FIG. 3) of the strip of foam material 16 and is attached to an inside face 25 of the strip of foam material 16. A lower edge portion 26 of the outer cover 12 is wrapped around a lower edge portion 28 (FIG. 3) of the strip of foam material 16 and is attached to the inside face 25 of the strip of foam material 16.

The inner cover 14 overlays and is attached to essentially an entire exposed portion of the inner face 25 of the strip of foam material 16. The entire exposed portion of the inner face 25 refers to the portion of the inside face 25 that is not covered by the upper and lower edge portions (22, 26) of the outer cover 12. Preferably, but not necessarily, upper and lower edge portions (28, 30) of the inner cover 14 over lay and are attached to the upper and lower edge portions (22, 26), respectively, of the outer cover 12. Preferably, but not necessarily, attachment of the outer cover 12 and the inner cover 14 includes bonding with an adhesive.

As shown in FIGS. 1 and 2, the covers (12, 14) and the strip of foam material 16 jointly form a sleeve body having opposing end portions (32, 34) that are attached at a connection interface 36. The sleeve body has a frusto-conical shape with a cup receiving passage 33. In one definition, frusto-conical refers to a funnel shaped sleeve with tapered sidewalls, an open top end and an open bottom end. In one embodiment, the upper and lower edges (24, 28) of the strip of foam material 16 are each arched such that the strip of foam material 16 takes on a frusto-conical shape when opposing end portions of the strip of foam material 16 are attached to each other.

It is disclosed herein that the outer and inner covers (12, 14) may be a single piece of material (i.e., an elongated cover). Such an elongated cover has opposing end portions thereof attached to each other such that the elongated cover forms a tapered sleeve body having an interior face (i.e., cup engaging face) and an exterior face (i.e., a hand engaging face). The elongated cover includes an interior space extending along substantially an entire length of the elongated cover. The strip of foam material 16 is disposed within the interior space of the elongated cover, extending along substantially an entire length of the elongated cover. It is disclosed herein that a strip of insulating material in accordance with the present invention may consist of several discrete pieces of insulating material or a plurality of interconnected segments of insulating material.

Referring to FIGS. 2 and 3, each one of the cup gripping members 18 is attached to the inner cover 14. The cup gripping members 18 are arranged in a circumferentially spaced apart manner. Preferably, but not necessarily, each one of the cup gripping members 18 is made from a polymeric material exhibiting a relative coefficient of friction substantially greater than a relative coefficient of friction exhibited by a cup engaging face 38 of the inner cover 14. Examples of such a polymeric material include, but are not limited to, a synthetic rubber, a thermoplastic elastomer, etc. Furthermore, each one of the cup gripping members preferably, but not necessarily, includes a textured cup engaging surface. As depicted in FIG. 3, in one embodiment, such a cup engaging surface includes a plurality of raised ribs 40. While, two cup gripping members 18 are shown, it is disclosed herein that embodiments of the present invention may include no cup gripping members, less than two cup gripping members or more than two cup gripping members.

In use, a cup with tapered side wall (e.g., a typical disposable paper or plastic coffee cup) is disposed within the cup receiving passage 33 of the thermally-insulating cup holding sleeve 10. The tapered side wall of the cup engages the cup engaging face 30 of the inner cover 14 such that cup becomes fixedly engaged with the thermally-insulating cup holding sleeve 10. In this manner, a person may handle the cup by grasping the thermally-insulating cup holding sleeve 10, thereby protecting their hand from heat transferred through the tapered side wall of the cup (i.e., heat from hot liquid such as coffee in the cup). Furthermore, the insulating properties of the thermally-insulating cup holding sleeve 10 serves to keep hot contents of the cup hotter or cold contents colder for a longer period of time than if the thermally-insulating cup holding sleeve 10 was not provided on the cup.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A thermally-insulating cup holding sleeve, comprising:
a frusto-conical shaped insulating core having an exterior face and an interior face, wherein the insulating core is made of a foam material;
an outer cover attached to the exterior face of the insulating core, wherein the outer cover is made of a cloth material; and
an inner cover attached to the inner face of the insulating core, wherein the inner cover is made of a cloth material.

2. The thermally-insulating cup holding sleeve of claim 1 wherein:
the outer cover is bonded to essentially an entire exposed portion of the exterior face of said insulating core;
upper and lower edge portions of the outer cover are each wrapped around a corresponding edge portion of said insulating core such that said edge portions of the outer cover overlay a portion of the interior face of said insulating core;
said edge portions of the outer cover are attached to the interior face of said insulating core; and
the inner cover is bonded to essentially an entire exposed portion of the interior face of said insulating core.

3. The thermally-insulating cup holding sleeve of claim 1, further comprising:
a plurality of cup gripping member attached to the inner cover, wherein said cup gripping members are arranged in a spaced apart manner along a length of said insulating core.

4. The thermally-insulating cup holding sleeve of claim 3 wherein each one of said cup gripping members is made from a polymeric material exhibiting a relative coefficient of friction substantially greater than a relative coefficient of friction exhibited by an expose face of said inner cover.

5. The thermally-insulating cup holding sleeve of claim 4 wherein each one of said cup gripping members includes a textured cup engaging surface.

6. The thermally-insulating cup holding sleeve of claim 5 wherein the textured cup engaging surface includes a plurality of raised ribs.

7. The thermally-insulating cup holding sleeve of claim 6 wherein:
the outer cover is bonded to essentially an entire exposed portion of the exterior face of said insulating core;
upper and lower edge portions of the outer cover are each wrapped around a corresponding edge portion of said insulating core such that said edge portions of the outer cover overlay a portion of the interior face of said insulating core;
said edge portions of the outer cover are attached to the interior face of said insulating core; and
the inner cover is bonded to essentially an entire exposed portion of the interior face of said insulating core.

8. A thermally-insulating cup holding sleeve, comprising:
a strip of foam material having opposing major faces, opposing end portions, an upper edge portion and a lower edge portion, wherein said opposing end portions are joined to each other, wherein said edge portions of the strip of foam material are correspondingly arched such that the strip of foam material forms a frusto-conical shaped sleeve when said opposing end portions are joined;
a first cloth cover overlying and attached to essentially an entire portion of a first one of said opposing major faces of the strip of foam material, wherein upper and lower edge portions of the first cloth cover are each wrapped around a corresponding one of said edge portions of the strip of foam material such that said edge portions of the first cloth cover each overlay a portion of a second one of said opposing major faces, wherein said edge portions of the first cloth cover are attached to the second one of said opposing major faces;
a second cloth cover overlying and attached to essentially an entire exposed portion of the second one of said opposing major faces, wherein upper and lower edge portions of the second cloth cover are each attached to a corresponding one of said edge portions of the first cloth cover; and
a plurality of cup gripping members attached to the second cloth cover, wherein said cup gripping members are arranged in a spaced apart manner between said opposing end portions of the strip of foam material.

9. The thermally-insulating cup holding sleeve of claim 8 wherein:
the first cloth cover is bonded to essentially an entire exposed portion of the first one of said opposing major faces of the strip of foam material; and
the second cloth cover is bonded to essentially an entire exposed portion of the second one of said opposing major faces of the strip of foam material.

10. The thermally-insulating cup holding sleeve of claim 8 wherein each one of said cup gripping members is made from a polymeric material exhibiting a relative coefficient of friction substantially greater than a relative coefficient of friction exhibited by an exposed face of the second cloth cover.

11. The thermally-insulating cup holding sleeve of claim 10 wherein each one of said cup gripping members includes a textured cup engaging surface.

12. The thermally-insulating cup holding sleeve of claim 11 wherein the textured cup engaging surface includes a plurality of raised ribs.

13. The thermally-insulating cup holding sleeve of claim 12 wherein:
the first cloth cover is bonded to essentially an entire exposed portion of the first one of said opposing major faces of the strip of foam material; and
the second cloth cover is bonded to essentially an entire exposed portion of the second one of said opposing major faces of the strip of foam material.

14. A thermally-insulating cup holding sleeve, comprising:
an elongated cover having opposing ends thereof attached to each other such that the elongated cover forms a tapered sleeve body having an interior face and an exterior face, wherein the elongated cover includes an interior space extending along substantially an entire length of the elongated cover;
a strip of foam material disposed within the interior space of the elongated cover, wherein the strip of foam material extends along substantially an entire length of the elongated cover; and
a plurality of cup gripping members attached in a spaced-apart manner to the interior face of the elongated cover.

15. The thermally-insulating cup holding sleeve of claim 14 wherein:
the strip of foam material is bonded to the elongated cover over essentially an entire interface area between the strip of foam material and the elongated cover.

16. The thermally-insulating cup holding sleeve of claim 15 wherein each one of said cup gripping members is made from a polymeric material exhibiting a relative coefficient of friction substantially greater than a relative coefficient of friction exhibited by a cup engaging face of the elongated cover.

17. The thermally-insulating cup holding sleeve of claim 16 wherein each one of said cup gripping members includes a textured cup engaging surface.

18. The thermally-insulating cup holding sleeve of claim 17 wherein the textured cup engaging surface includes a plurality of raised ribs.

19. The thermally-insulating cup holding sleeve of claim 14 wherein:
the strip of foam material is bonded to the elongated cover over essentially an entire interface area between the strip of foam material and the elongated cover.
